(19) United States
(12) Patent Application Publication
(10) Pub. No.: US 2026/0305719 A1
(43) Pub. Date: Oct. 8, 2026

(54) AEROSOL DELIVERY CONTROLLERS, SYSTEMS AND METHODS

(71) Applicant: Nicoventures Trading Limited, London (GB)

(72) Inventor: Scott George BOHAM, Romsey (GB)

(21) Appl. No.: 19/474,761

(22) PCT Filed: Apr. 10, 2024
(86) PCT No.: PCT/GB2024/050938

§ 371 Date: Oct. 13, 2025

(30) Foreign Application Priority Data
Apr. 13, 2023 (GB) 2305414.1

(51) Int. Cl. A24F 40/57; A24F 40/42; A24F 40/53; H05B 1/02; H05B 3/03

(52) U.S. Cl. CPC A24F 40/57; A24F 40/42; A24F 40/53; H05B 1/0252; H05B 3/03

(57) ABSTRACT

A controller for an aerosol delivery system comprising an aerosol generator configured to generate aerosol from aerosol-generating material, the controller being configured to: for a first time period, repeatedly measure a parameter of an aerosol generator or an aerosol-generating material and, in response, dynamically control a first, variable power supplied to the aerosol generator, dependent on the measured parameter; and after the first time period, supply a second, constant power to the aerosol generator.

### CROSS-REFERENCE TO RELATED APPLICATIONS

This present application is a National Phase entry of PCT Application No. PCT/GB2024/050938, filed 10 Apr. 2024, which claims priority from Great Britain Application No. 2305414.1, filed 13 Apr. 2023, each of which are fully incorporated herein by reference in their entireties.

### FIELD

The present disclosure relates to aerosol delivery systems such as, but not exclusively, nicotine delivery systems (e.g. e-cigarettes).

### BACKGROUND

Aerosol delivery systems such as electronic cigarettes (e-cigarettes) generally contain an aerosol generating material, such as a chamber of a source solid or liquid, which may contain an active substance and/or a flavour, from which an aerosol or vapour is generated for inhalation by a user, for example through heat vaporisation. Thus, an aerosol delivery system will typically comprise an aerosol generation area containing an aerosol generator, e.g. a heating element, arranged to vaporise or aerosolise a portion of precursor material to generate a vapour or aerosol in the aerosol generation area. As a user inhales on the device and electrical power is supplied to the vaporiser, air is drawn into the device through an inlet hole and along an inlet air channel connecting to the aerosol generation area, where the air mixes with vaporised precursor material to form a condensation aerosol. There is an outlet channel connecting the aerosol generation area to an outlet in the mouthpiece and the air drawn into the aerosol generation area as a user inhales on the mouthpiece continues along the outlet flow path to the mouthpiece outlet, carrying the aerosol with it, for inhalation by the user. Some electronic cigarettes may also include a flavour element in the air flow path through the device to impart additional flavours. Such devices may sometimes be referred to as hybrid devices, and the flavour element may, for example, include a portion of tobacco arranged in the air flow path between the aerosol generation area and the mouthpiece such that aerosol/condensation aerosol drawn through the device passes through the portion of tobacco before exiting the mouthpiece for user inhalation.

WO2022064172 and WO2015/100361 disclose aerosol provision systems.

User experiences with electronic aerosol delivery systems are continually improving as such systems become more refined in respect of the nature of the vapour they provide for user inhalation, for example in terms of deep lung delivery, mouth feel and consistency in performance. Nonetheless, approaches for improving further still on these aspects remain of interest. In particular, it is of interest to develop approaches in which an aerosol delivery system comprises functionality enabling operating characteristics of the system to be consistent and/or adjustable, in order to target certain operating characteristics which may be desirable to a user. Furthermore, it is of interest to develop approaches in which power efficiency is increased.

Various approaches are described herein which seek to help address or mitigate at least some of the issues discussed above.

### Terminology

### Delivery System

As used herein, the term “delivery system” is intended to encompass systems that deliver at least one substance to a user in use, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

### Combustible Aerosol Provision System

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar. In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

### Non-Combustible Aerosol Provision System

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery system (END), although it is noted that the presence of nicotine in the aerosol-generating material is not a requirement. In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent. In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

### Aerosol-Free Delivery System

In some embodiments, the delivery system is an aerosol-free delivery system that delivers at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

### Active Substance

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes. As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like.

Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco. In some embodiments, the active substance comprises or derived from one or more botanicals or constituents, derivatives or extracts thereof and the botanical is selected from eucalyptus, star anise, cocoa and hemp. In some embodiments, the active substance comprises or derived from one or more botanicals or constituents, derivatives or extracts thereof and the botanical is selected from rooibos and fennel.

### Flavours

In some embodiments, the substance to be delivered comprises a flavour. As used herein, the terms “flavour” and “flavourant” refer to materials which, where local regulations permit, may be used to create a desired taste, aroma or other somatosensorial sensation in a product for adult consumers.

They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

They may be in any suitable form, for example, liquid such as an oil, solid such as a powder, or gas. In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

### Aerosol-Generating Material

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50wt %, 60wt % or 70wt % of amorphous solid, to about 90wt %, 95wt % or 100wt % of amorphous solid.

The aerosol-generating material may comprise one or more active substances and/or flavours, one or more aerosol-former materials, and optionally one or more other functional material.

### Aerosol-Former Material

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

### Functional Material

The one or more other functional materials may comprise one or more of pH regulators, colouring agents, preservatives, binders, fillers, stabilizers, and/or antioxidants.

### Substrate

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

### Consumable

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

### Susceptor

A susceptor is a material that is heatable by penetration with a varying magnetic field, such as an alternating magnetic field. The susceptor may be an electrically-conductive material, so that penetration thereof with a varying magnetic field causes induction heating of the heating material.

The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

### Aerosol-Modifying Agent

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent. The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

### Aerosol Generator

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

The present disclosure relates to aerosol delivery systems (which may also be referred to as vapour delivery systems) such as nebulisers or e-cigarettes. Throughout the following description the term “e-cigarette” or “electronic cigarette” may sometimes be used, but it will be appreciated this term may be used interchangeably with aerosol delivery system/device and electronic aerosol delivery system/device. Furthermore, and as is common in the technical field, the terms “aerosol” and “vapour”, and related terms such as “vaporise”, “volatilise” and “aerosolise”, may generally be used interchangeably.

Aerosol delivery systems (e-cigarettes) often, though not always, comprise a modular assembly comprising a reusable device part and a replaceable (disposable/consumable) cartridge part. Often, the replaceable cartridge part will comprise the aerosol generating material and the vaporiser (which may collectively be called a ‘cartomizer’) and the reusable device part will comprise the power supply (e.g. rechargeable power source) and control circuitry. It will be appreciated these different parts may comprise further elements depending on functionality. For example, the reusable device part will often comprise a user interface for receiving user input and displaying operating status characteristics, and the replaceable cartridge device part in some cases comprises a temperature sensor for helping to control temperature. Cartridges are electrically and mechanically coupled to the control unit for use, for example using a screw thread, bayonet, or magnetic coupling with appropriately arranged electrical contacts. When the aerosol generating material in a cartridge is exhausted, or the user wishes to switch to a different cartridge having a different aerosol generating material, the cartridge may be removed from the reusable part and a replacement cartridge attached in its place. Systems and devices conforming to this type of two-part modular configuration may generally be referred to as two-part systems/devices.

It is common for electronic cigarettes to have a generally elongate shape. For the sake of providing a concrete example, certain embodiments of the disclosure will be taken to comprise this kind of generally elongate two-part system employing disposable cartridges. However, it will be appreciated that the underlying principles described herein may equally be adopted for different configurations, for example single-part systems or modular systems comprising more than two parts, refillable devices and single-use disposables, as well as other overall shapes, for example based on so-called box-mod high performance devices that typically have a boxier shape. More generally, it will be appreciated certain embodiments of the disclosure are based on aerosol delivery systems which are operationally configured to provide functionality in accordance with the principles described herein and the constructional aspects of systems configured to provide the functionality in accordance with certain embodiments of the disclosure is not of primary significance.

### BRIEF SUMMARY OF THE INVENTION

The present invention provides a controller for an aerosol delivery system and a method for controlling an aerosol delivery system as claimed. The present invention further provides additional embodiments as claimed in the dependent claims.

The claimed invention generally provides a sub-assembly or sub-system suitable for use in an aerosol delivery system, or configured for use in an aerosol delivery system. The sub-system may generally form part of an aerosol delivery system and in particular may form part of the reusable device and/or the consumable cartridge.

In particular, the claimed arrangements may increase consistency of performance whilst simplifying control and thereby optimising power efficiency. More specifically, the claimed arrangement having a dynamic first stage of control compensates for the unknown state of the system, which may for example be unused, such as brand new, or dormant and thus cold, or recently used and thus hot, or anything in between—the dynamic control accommodates for this and stabilises the system. Thereafter, once the system is in or approaching steady state, a second stage comprising steady-state control is applied, reducing computational complexity and thereby power consumption. Furthermore, applying constant power in the second stage means that if the aerosol-generating material becomes depleted then the system will generate a slight burnt taste, clearly informing the user that the aerosol-generating material is depleted and ready to be replaced/replenished.

### BRIEF DESCRIPTION OF THE FIGURES

Embodiments of the disclosure will now be described, by way of example only, with reference to the accompanying drawings, in which:

FIG. 1 is a schematic cross-section view of an aerosol delivery system in accordance with some embodiments of the disclosure.

FIG. 2 is a simplified, schematic graph illustrating temperature and power versus time for an aerosol generator in an aerosol delivery system comprising a proportional controller.

FIG. 3 is a simplified, schematic graph illustrating temperature and power versus time for an aerosol generator in an aerosol delivery system comprising a proportional-integral-derivative (PID) controller with pulse width modulation (PWM).

### DETAILED DESCRIPTION OF THE DISCLOSURE

Aspects and features of certain examples and embodiments are described herein. Some aspects and features of certain examples and embodiments may be implemented conventionally and these are not described in detail in the interest of brevity. It will thus be appreciated that aspects and features of apparatuses and methods discussed herein which are not described in detail may be implemented in accordance with any suitable conventional techniques.

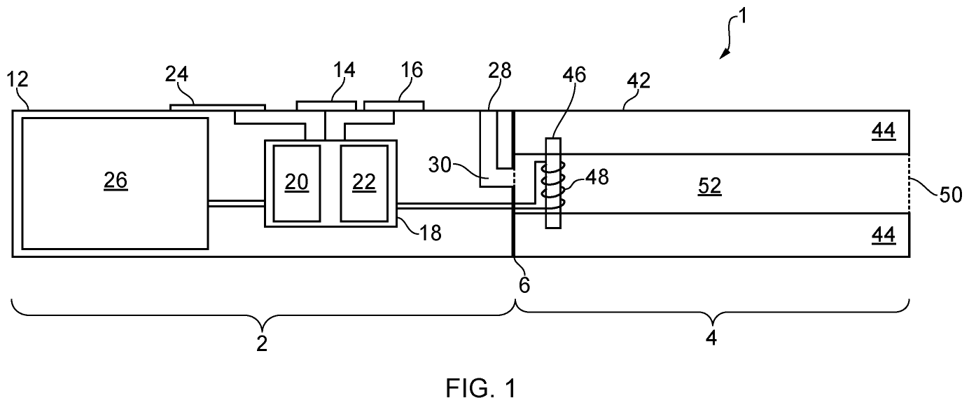

FIG. 1 is a cross-sectional view through an example aerosol delivery system 1 in accordance with certain embodiments of the disclosure, providing an introduction to two-part aerosol delivery systems, the components therein and their functionality.

The aerosol delivery system 1 comprises two main parts, namely a reusable part 2 and a replaceable/disposable consumable cartridge part 4. In normal use, the reusable part 2 and the cartridge part 4 are releasably coupled together at an interface 6. When the cartridge part 4 is exhausted or the user simply wishes to switch to a different cartridge part 4, the cartridge part 4 may be removed from the reusable part 2 and a replacement cartridge part 4 attached to the reusable part 2 in its place. The interface 6 provides a structural, electrical and airflow path connection between the two parts 2, 4 and may be established in accordance with conventional techniques, for example based around a screw thread, magnetic or bayonet fixing with appropriately arranged electrical contacts and openings for establishing the electrical connection and airflow path between the two parts 2, 4 as appropriate. The specific manner by which the cartridge part 4 mechanically mounts to the reusable part 2 is not significant to the principles described herein, but for the sake of a concrete example is assumed here to comprise a magnetic coupling (not represented in FIG. 1). It will also be appreciated the interface 6 in some implementations may not support an electrical and/or airflow path connection between the respective parts 2, 4. For example, in some implementations an aerosol generator may be provided in the reusable part 2 rather than in the cartridge part 4, or the transfer of electrical power from the reusable part 2 to the cartridge part 4 may be wireless (e.g. based on electromagnetic induction), so that an electrical connection between the reusable part 2 and the cartridge part 4 is not needed. Furthermore, in some implementations the airflow through the electronic cigarette might not go through the reusable part 2, so that an airflow path connection between the reusable part 2 and the cartridge part 4 is not needed. In some instances, a portion of the airflow path may be defined at the interface between portions of the reusable part 2 and cartridge part 4 when these are coupled together for use.

The cartridge/consumable part 4 may in accordance with certain embodiments of the disclosure be broadly conventional. In FIG. 1, the cartridge part 4 comprises a cartridge housing 42 formed of a plastics material. The cartridge housing 42 supports other components of the cartridge part 4 and provides the mechanical interface 6 with the reusable part 2. The cartridge housing 42 is generally circularly symmetric about a longitudinal axis along which the cartridge part 4 couples to the reusable part 2. In this example, the cartridge part 4 has a length of around 4 cm and a diameter of around 1.5 cm. However, it will be appreciated the specific geometry, and more generally the overall shapes and materials used, may be different in different implementations.

Within the cartridge housing 42 is a chamber or reservoir 44 that contains aerosol-generating material. In the example shown schematically in FIG. 1, the reservoir 44 stores a supply of liquid aerosol generating material. In this example, the liquid reservoir 44 has an annular shape with an outer wall defined by the cartridge housing 42 and an inner wall that defines an airflow path 52 through the cartridge part 4. The reservoir 44 is closed at each end with end walls to contain the aerosol generating material. The reservoir 44 may be formed in accordance with conventional techniques, for example it may comprise a plastics material and be integrally moulded with the cartridge housing 42.

The cartridge/consumable part 4 further comprises an aerosol generator 48 located towards an end of the reservoir 44 opposite to a mouthpiece outlet 50. It will be appreciated that in a two-part system such as shown in FIG. 1, the aerosol generator 48 may be in either of the reusable part 2 or the cartridge part 4. For example, in some embodiments, the aerosol generator 48 (e.g. a heater, which may be in the form of a wick and coil arrangement as shown, a distiller, which may be formed from a sintered metal fibre material or other porous conducting material, or any suitable alternative aerosol generator) may be comprised in the reusable part 2, and is brought into proximity with a portion of aerosol generating material in the cartridge part 4 when the cartridge part 4 is engaged with the reusable part 2. In such embodiments, the cartridge part 4 may comprise a portion of aerosol generating material, and an aerosol generator 48 comprising a heater is at least partially inserted into or at least partially surrounds the portion of aerosol generating material as the cartridge part 4 is engaged with the reusable part 2.

In the example of FIG. 1, a wick 46 in contact with the aerosol generator 48 extends transversely across the cartridge airflow path 52 with its ends extending into the reservoir 44 of the liquid aerosol generating material through openings in the inner wall of the reservoir 44. The openings in the inner wall of the reservoir 44 are sized to broadly match the dimensions of the wick 46 to provide a reasonable seal against leakage from the liquid reservoir 44 into the cartridge airflow path without unduly compressing the wick 46, which may be detrimental to its fluid transfer performance.

The wick 46 and aerosol generator 48 are arranged in the cartridge airflow path 52 such that a region of the cartridge airflow path 52 around the wick 46 and heater 48 in effect defines a vaporisation region for the cartridge part 4. Aerosol generating material in the reservoir 44 infiltrates the wick 46 through the ends of the wick extending into the reservoir 44 and is drawn along the wick by surface tension/capillary action (i.e. wicking). The aerosol generator 48 in this example comprises an electrically resistive wire coiled around the wick 46. In the example of FIG. 1, the heater 48 comprises a nickel chrome alloy (Cr20Ni80) wire and the wick 46 comprises a glass fibre bundle, but it will be appreciated the specific aerosol generator configuration is not significant to the principles described herein. In use, electrical power may be supplied to the aerosol generator 48 to vaporise an amount of aerosol generating material (aerosol generating material) drawn to the vicinity of the aerosol generator 48 by the wick 46. Vaporised aerosol generating material may then become entrained in air drawn along the cartridge airflow path from the vaporisation region towards the mouthpiece outlet 50 for user inhalation.

As noted above, the rate at which aerosol generating material is vaporised by the aerosol generator 48 will depend on the amount (level) of power supplied to the aerosol generator 48. Thus electrical power can be applied to the aerosol generator 48 to selectively generate aerosol from the aerosol generating material in the cartridge part 4, and furthermore, the rate of aerosol generation can be changed by changing the amount of power supplied to the aerosol generator 48, for example through pulse width and/or frequency modulation techniques.

The reusable part 2 comprises an outer housing 12 having with an opening that defines an air inlet 28 for the e-cigarette, a power source 26 (for example a battery) for providing operating power for the electronic cigarette, control circuitry/controller 22 for controlling and monitoring the operation of the electronic cigarette, a first user input button 14, a second user input button 16, and a visual display 24.

The outer housing 12 may be formed, for example, from a plastics or metallic material and in this example has a circular cross section generally conforming to the shape and size of the cartridge part 4 so as to provide a smooth transition between the two parts 2, 4 at the interface 6. In this example, the reusable part 2 has a length of around 8 cm so the overall length of the e-cigarette when the cartridge part 4 and the reusable part 2 are coupled together is around 12 cm. However, and as already noted, it will be appreciated that the overall shape and scale of an electronic cigarette implementing an embodiment of the disclosure is not significant to the principles described herein.

The air inlet 28 connects to an airflow path 51 through the reusable part 2. The reusable part airflow path 51 in turn connects to the cartridge airflow path 52 across the interface 6 when the reusable part 2 and cartridge part 4 are connected together. Thus, when a user inhales on the mouthpiece opening 50, air is drawn in through the air inlet 28, along the reusable part airflow path 51, across the interface 6, through the aerosol generation area in the vicinity of the aerosol generator 48 (where vaporised aerosol generating material becomes entrained in the air flow), along the cartridge airflow path 52, and out through the mouthpiece opening 50 for user inhalation.

The power source 26 in this example is rechargeable and may be of a conventional type, for example of the kind normally used in electronic cigarettes and other applications requiring provision of relatively high currents over relatively short periods. The power source 26 may be recharged through a charging connector in the reusable part housing 12, for example a USB connector.

First and/or second user input buttons 14, 16 may be provided, which in this example are conventional mechanical buttons, for example comprising a spring mounted component which may be pressed by a user to establish an electrical contact. In this regard, the input buttons may be considered input devices for detecting user input and the specific manner in which the buttons are implemented is not significant. The buttons may be assigned to functions such as switching the aerosol delivery system 1 on and off, and adjusting user settings such as a power to be supplied from the power source 26 to the aerosol generator 48. However, the inclusion of user input buttons is optional, and in some embodiments buttons may not be included.

A display 24 may be provided to give a user with a visual indication of various characteristics associated with the aerosol delivery system, for example current power setting information, remaining power source power, and so forth. The display may be implemented in various ways. In this example the display 24 comprises a conventional pixilated LCD screen that may be driven to display the desired information in accordance with conventional techniques. In other implementations, the display may comprise one or more discrete indicators, for example LEDs, that are arranged to display the desired information, for example through particular colours and/or flash sequences. More generally, the manner in which the display 24 is provided and information is displayed to a user using the display is not significant to the principles described herein. For example, some embodiments may not include a visual display and/or may include other means for providing a user with information relating to operating characteristics of the aerosol delivery system, for example using audio signalling, or may not include any means for providing a user with information relating to operating characteristics of the aerosol delivery system.

A controller 22 is suitably configured/programmed to control the operation of the aerosol delivery system 1 to provide functionality in accordance with embodiments of the disclosure as described further herein, as well as for providing conventional operating functions of the aerosol delivery system 1 in line with the established techniques for controlling such devices. The controller (processor circuitry) 22 may be considered to logically comprise various sub-units/circuitry elements associated with different aspects of the operation of the aerosol delivery system 1. In this example the controller 22 comprises power supply control circuitry for controlling the supply of power from the power source 26 to the aerosol generator 48 in response to user input, user programming circuitry 20 for establishing configuration settings (e.g. user-defined power settings) in response to user input, as well as other functional units/circuitry associated functionality in accordance with the principles described herein and conventional operating aspects of electronic cigarettes, such as display driving circuitry and user input detection circuitry. It will be appreciated that the functionality of the controller 22 can be provided in various different ways, for example using one or more suitably programmed programmable computer(s) and/or one or more suitably configured application-specific integrated circuit(s)/circuitry/chip(s)/chipset(s) configured to provide the desired functionality.

The functionality of the controller 22 is described further herein. For example, the controller 22 may comprise an application specific integrated circuit (ASIC) or microcontroller, for controlling the aerosol delivery device. The microcontroller or ASIC may include a CPU or micro-processor. The operations of a CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required.

The reusable part 2 comprises an airflow sensor 30 which is electrically connected to the controller 22. In most embodiments, the airflow sensor 30 comprises a so-called “puff sensor”, in that the airflow sensor 30 is used to detect when a user is puffing on the device. In some embodiments, the airflow sensor 30 comprises a switch in an electrical path providing electrical power from the power source 26 to the aerosol generator 48. In such embodiments, the airflow sensor 30 generally comprises a pressure sensor configured to close the switch when subjected to a particular range of pressures, enabling current to flow from the power source 26 to the aerosol generator 48 once the pressure in the vicinity of the airflow sensor 30 drops below a threshold value. The threshold value can be set to a value determined by experimentation to correspond to a characteristic value associated with the initiation of a user puff. In other embodiments, the airflow sensor 30 is connected to the controller 22, and the controller distributes electrical power from the power source 26 to the aerosol generator 48 in dependence of a signal received from the airflow sensor 30 by the controller 22. The specific manner in which the signal output from the airflow sensor 30 (which may comprise a measure of capacitance, resistance or other characteristic of the airflow sensor, made by the controller 22) is used by the controller 22 to control the supply of power from the power source 26 to the aerosol generator 48 can be carried out in accordance with any approach known to the skilled person.

In the example shown in FIG. 1, the airflow sensor 30 is mounted to a printed circuit board (PCB) 31, but this is not essential. The airflow sensor 30 may comprise any sensor which is configured to determine a characteristic of airflow in an airflow path 51 disposed between air inlet 28 and mouthpiece opening 50, for example a pressure sensor or transducer (for example a membrane or solid-state pressure sensor), a combined temperature and pressure sensor, or a microphone (for example an electret-type microphone), which is sensitive to changes in air pressure, including acoustical signals. The airflow sensor 30 is situated within a sensor cavity or chamber 32, which comprises the interior space defined by one or more chamber walls 34. The sensor cavity 32 comprises a region internal to one or more chamber walls 34 in which an airflow sensor 30 can be fully or partially situated. In some embodiments, the PCB 31 comprises one of the chamber walls of a sensor housing comprising the sensor chamber/cavity 32.

A deformable membrane is disposed across an opening communicating between the sensor cavity 32 containing the sensor 30, and a portion of the airflow path disposed between air inlet 28 and mouthpiece opening 50. The deformable membrane covers the opening, and is attached to one or more of the chamber walls according to approaches described further herein.

As described further herein, the aerosol delivery system 1 comprises communication circuitry configured to enable a connection to be established with one or more further electronic devices (for example, a storage/charging case, and/or a refill/charging dock) to enable data transfer between the aerosol delivery system 1 and further electronic device(s). In some embodiments, the communication circuitry is integrated into controller 22, and in other embodiments it is implemented separately (comprising, for example, separate application-specific integrated circuit(s)/circuitry/chip(s)/chipset(s)). For example, the communication circuitry may comprise a separate module to the controller 22 which, while connected to controller 22, provides dedicated data transfer functionality for the aerosol delivery device. In some embodiments, the communication circuitry is configured to support communication between the aerosol delivery system 1 and one or more further electronic devices over a wireless interface. The communication circuitry may be configured to support wireless communications between the aerosol delivery system 1 and other electronic devices such as a case, a dock, a computing device such as a smartphone or PC, a base station supporting cellular communications, a relay node providing an onward connection to a base station, a wearable device, or any other portable or fixed device which supports wireless communications.

Wireless communications between the aerosol delivery system 1 and a further electronic device may be configured according to data transfer protocols such as Bluetooth®, ZigBee, WiFi®, Wifi Direct, GSM, 2G, 3G, 4G, 5G, LTE, NFC, RFID, or generally any other wireless, and/or wired, network protocol or interface. The communication circuitry may comprise any suitable interface for wired data connection, such as USB-C, micro-USB or Thunderbolt interfaces, and may comprise pin or contact pad arrangements configured to engage cooperating pins or contact pads on a dock, case, cable, or other external device which can be connected to the aerosol delivery system 1. The various sub-assemblies may comprise one or more processors and data processing steps may be performed on any of these processors or on a remote processor, the data communicated by wire or wirelessly.

Further functionality of the controller 22 is now described in more detail. In particular, the controller 22 is capable of providing dynamic control and steady state control for a puff, and switches between these control modes depending on a parameter (e.g. temperature) of the aerosol generator 48 or aerosol-generating material for the system during the puff. The controller 22 may also be capable of empirically determining a steady-state approximation for power control, as is described later.

In one embodiment, the controller 22 is configured to: for a first time period, repeatedly measure a parameter of an aerosol generator 48 or an aerosol-generating material and, in response, dynamically control a first, variable power supplied to the aerosol generator 48, dependent on the measured parameter; and after the first time period, supply a second, constant (steady state) power to the aerosol generator 48. The controller 22 can thereby provide dynamic then steady-state control for a single puff.

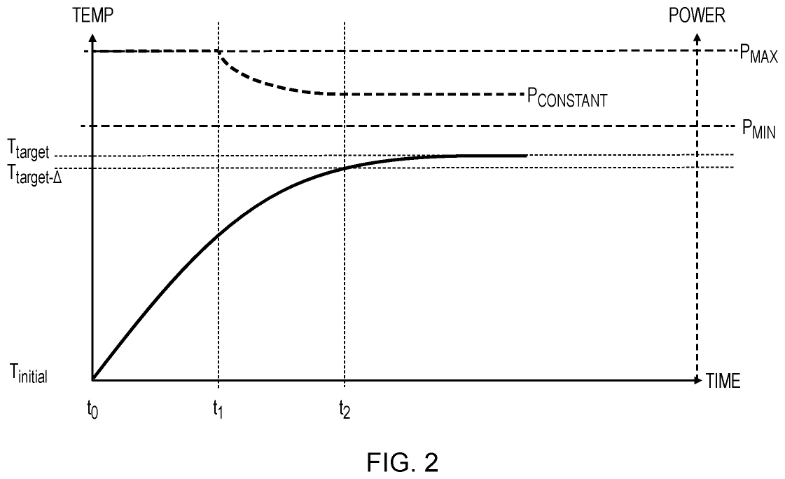

FIG. 2 is a schematic, simplified graph illustrating temperature and power versus time for an aerosol generator 48 in an aerosol delivery system 1 comprising a proportional controller 22. FIG. 2 shows how the aerosol generator 48 starts at an initial temperature Tᵢₙᵢₜᵢₐₗ at time t₀, before the user begins puffing for a first puff, after which the aerosol generator 48 is heated under dynamic, proportional control, receiving full/max power P_{MAX} (which may be determined or limited by the controller 22, the power supply 26, the aerosol generator 48 or the aerosol generating material) until t₁ (approximately halfway until t₂), thereafter the controller 22 proportionally reduces power based on the temperature delta to T_{target}, to slow the heating curve until t₂, when the aerosol generator 48 has reached a temperature of T_{target-Δ}.

After time t₂, the controller 22 switches from dynamic (proportional) control to steady-state control, and supplies a constant power P_{CONSTANT} to the aerosol generator 48, which continues the final heating necessary to reach T_{target} and then substantially maintains the steady state at T_{target} Within acceptable limits, e.g. within a tolerance of +/−5, 10 or 20° C. or +/−2.5%, 5%, or 10%. In this figure, P_{CONSTANT} is approximately 40% of P_{MAX} and may be pre-programmed, but may be adjustable within limits, dependent on various factors. More generally, P_{CONSTANT} depends on the designed P_{MAX} of the system and the aerosol generator (which may be a heater) and may typically be anywhere in the range of 30-70%, e.g. substantially ≤70%, ≤60%, ≤50%, ≤40% or ≤30% of a maximum power.

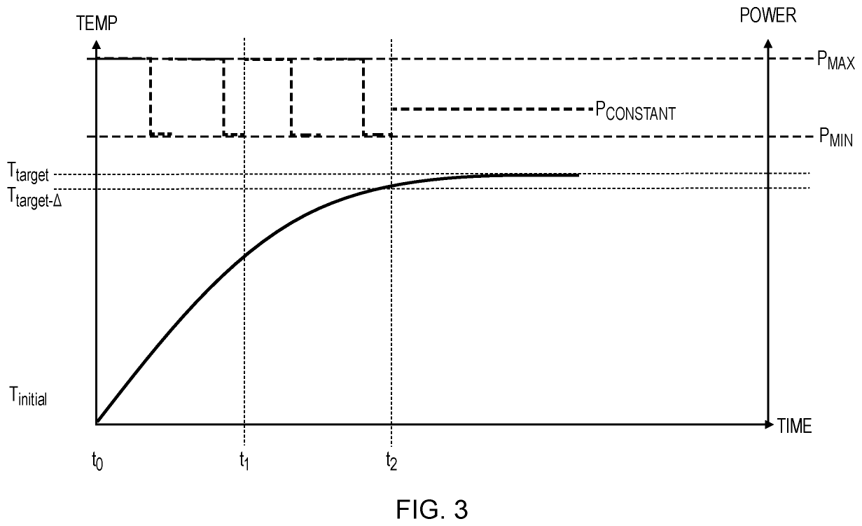

FIG. 3 is a schematic, simplified graph illustrating temperature and power versus time for an aerosol generator 48 in an aerosol delivery system 1 comprising a proportional-integral-derivative (PID) controller 22 using pulse width modulation (PWM). Key differences to that of FIG. 2 are outlined here. Principally, the controller 22 in FIG. 3 differs to that of FIG. 2 by comprising a PID controller using PWM to moderate the power output. In the example of FIG. 3, the PID controller 22 supplies maximum power at its maximum duty cycle rate of ~80% until t₁, approximately halfway until t₂, thereafter the PID controller reduces the duty cycle to slow the heating curve until t₂, when the aerosol generator 48 has reached a temperature of T_{target-Δ}. More generally, the maximum duty cycle rate may be close to 100%, e.g. >95%, due to the very short “off” period needed to measure resistance. Again, after time t₂, the controller 22 switches from dynamic (PID) control to steady-state control, and supplies a constant power P_{CONSTANT} to the aerosol generator 48, which continues the final heating necessary to reach T_{target} and then substantially maintains the steady state at T_{target} within acceptable limits as above. In this figure, P_{CONSTANT} is again approximately 40% of P_{MAX}. More generally, the second, constant (steady state) power may be substantially e.g. ≤70%, ≤60%, ≤50%, ≤40% or ≤30% of a maximum power; or ≤70%, ≤60%, ≤50%, ≤40% or ≤30% of a maximum duty cycle; or ≤70%, ≤60%, ≤50%, ≤40% or ≤30% absolute duty cycle.

The condition or trigger for switching from dynamic to steady state control is key and may be based on any suitable parameter indicating that the system is in or approaching steady state, and may be determined by the controller 22.

If the switch occurs at a time t₁, as illustrated in FIGS. 2 and 3, then a first time period from t₀ to t₁, defining when the switch occurs from the initial state at t₀, may be any one or more of:
a predetermined (known in advance) time period, such as an established time for the system to be suitably pre-heated, ready for a puff, e.g. substantially within the range 0.1-5 seconds, 0.25-2.5 seconds, 0.3-1.5 seconds or 0.5-1.0 seconds;
a time period until the measured parameter reaches a target value, optionally for at least a threshold length of time, such as reaching a predetermined temperature of the aerosol generator 48 (e.g. T_{target} or T_{target-Δ}), or equally reaching a predetermined resistance thereof which can be correlated to temperature, as is well-established in the art;
a time period until a predetermined difference between a target value and the measured parameter is reached (e.g. T_{target-Δ});
a time period until a predetermined first supplied power or duty cycle is reached (e.g.

substantially ≤70%, ≤60%, ≤50%, ≤40% or ≤30% of a maximum power that can be supplied; or substantially ≤70%, ≤60%, ≤50%, ≤40% or ≤30% of a maximum duty cycle (e.g. 95%); or substantially ≤70%, ≤60%, ≤50%, ≤40% or ≤30% absolute duty cycle), or has been supplied for at least a threshold length of time or number of cycles.

As shown in FIGS. 2 and 3, the power input required typically falls exponentially from maximum as the target temperature T_{target} is approached, and thus once the supply power falls below a predetermined first supplied power or duty cycle, the power required to reach and maintain T_{target} rarely increases significantly within the same puff. Nevertheless, fluctuations can be accounted for and avoid triggering the switch too early e.g. by requiring a minimum supply time or number of cycles at (or above/below) the threshold.

In some embodiments, the first time period and/or the steady state second, constant power may be determined by the controller 22, e.g. based on a user's preceding puff, optionally using a calibration process, or based on a user's puff pattern, the latter comprising a profile of puff parameters (e.g. puff duration, draw pressure and/or profile, aerosol generator temperature) from multiple puffs that the controller 22 is configured to analyse and/or monitor. For example, the controller 22 may be calibrated using a calibration process where the user uses the system for a typical single puff or puffing session comprising multiple puffs, where dynamic control is applied throughout and the controller 22 then subsequently analyses the puff/puffing session and determines where dynamic control is not essential and steady-state control could be used instead, to simplify calculation and save power for future puffs. Alternatively, the controller 22 may receive puff pattern data input by a user or transferred from another device, for similar analysis by the controller 22. The system may comprise a puff sensor 30 to determine puff parameters.

In a first simple example, the first time period is determined as a predetermined fraction or fixed percentage such as substantially 25%, 50% or 75% of the user's preceding puff duration, optionally subject to a minimum time period for the device to stabilise, of e.g. 0.25-0.5 s. Generally speaking, for at least the second half or final quarter of a puff, the aerosol generator 48 can be assumed to be in a steady state, thus can be switched to constant power with minimal negative consequence to the user. The fraction may be based on any average (mean/median/mode) of the user's puff pattern (e.g. all monitored puffs), any single puff (e.g. a shortest/longest/mean puff) or any intermediate range (e.g. all puffs excluding extremes).

In a second example, the controller 22 is configured to determine the second, constant (steady state) power by applying a steady-state approximation of the dynamic supply power from at least part of a single earlier puff or multiple puff session, e.g. by identifying a puffing time window having minimal power supply variation. For example, the controller 22 may determine that for a single or multiple puffs, after time t₁ seconds, the PWM duty cycle remains within a small variance window (e.g. ≤10%, ≤5% or ≤2.5% of a mean value, such as between 39-43% duty cycle with a time-weighted average of 41.8%), therefore steady-state control could be used instead of dynamic control.

The controller 22 may thus empirically determine that:
steady state power could be applied after time t₁, thus the first time period may be set as t₁, optionally with a margin of error applied (e.g. +/−5%); or alternatively, based on the PWM threshold, setting the first time period to be a time period until the PWM duty cycle falls below e.g. the upper (43%), lower (39%) or average (41.8%) limit of the variance window, again optionally with a margin of error; and/or
the steady-state power supplied could be set to e.g. the time-weighted duty cycle average (41.8%), the median/mode of the session, or at a standard default fixed condition (e.g. 40% duty cycle), again optionally with a margin of error applied (e.g. +/−5%, which may be calculated dependent on the time-weighted duty cycle average).

In some embodiments, the controller 22 is configured to apply a margin of error of ≤2.5%, ≤5%, ≤10%, ≤15% or ≤20% to the determined parameters based on the user's preceding puff or puff pattern.

In a further embodiment, a linear approximation may be used instead of a steady state approximation and the controller 22 is configured to supply two levels or stages of constant power, e.g. the controller 22 is configured to supply the second, constant power to the aerosol generator 48 for a second time period and thereafter, supply a third, constant power to the aerosol generator 48. In a yet further embodiment, a linear reduction in power may be applied after t₂, at a certain fixed rate (e.g. 1 watt per second). This could help to prevent the temperature rising too high in the event the user puffs very slowly, and also encourage users to take shorter puffs as the amount of vapour would tail off.

In further embodiments, the system comprises a sensor for identifying the aerosol-generating material. The controller 22 may be further configured to adjust any parameter dependent on the identification, such as the first time period; a range for the first, variable power supplied to the aerosol generator 48 for the first time period; and/or the second, constant power supplied after the first time period. Accordingly, these parameters may be adapted based on the aerosol-generating material in use, tailoring the experience to optimise consistency across different aerosol-generating materials. The system may comprise a look-up table for the parameters for various aerosol-generating materials, or be able to transfer data via wireless communication e.g. to a connected smartphone, to retrieve suitable parameters.

FIGS. 2 and 3 illustrate proportional and PID PWM control respectively. In a further embodiment, the controller 22 provides a simplified dynamic controller that utilises a threshold to determined one of two possible predetermined outputs. This beneficially provides more control than a steady state system, but avoids the computational complexity and delay of PID control. Here, the first, variable power is determined by:
if the target value exceeds the measured parameter by greater than or equal to a first predetermined amount, then supplying a first predetermined power to the heater; and
if the target value exceeds the measured parameter but by less than the first predetermined amount, then supplying a second predetermined power to the heater that is lower than the first power.

In some embodiments, the controller 22 has a cycle time of 1-10 ms and the controller 22 is configured to measure the parameter every 1-10 ms and control the first, variable power supplied to the aerosol generator 48 dependent on the measured parameter, to provide a highly responsive system during dynamic control.

In some embodiments, the controller 22 comprises overheat safety protection and monitors the measured parameter, optionally at a significantly reduced interval for the steady state stage as compared to the dynamic control stage (e.g. every 100, 250, 500 or 1000 ms), then reduces the second, constant power or cuts power entirely should the measured parameter exceed an overheat threshold.

The measured parameter itself may be any suitable parameter of the system, particularly of the aerosol generator 48 or aerosol-generating material. In some embodiments, the target value for and measured parameter of the aerosol generator 48 or aerosol-generating material relate to a temperature or resistance of the aerosol generator 48, or a temperature or viscosity of the aerosol-generating material.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention.

Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future. Protection may also be sought for any features disclosed in any one or more published documents referenced herein in combination with the present disclosure.

### INDEX TO REFERENCE NUMERALS

1 aerosol delivery system
2 reusable part
4 cartridge part
6 interface between reusable part and cartridge part
12 reusable part housing
14, 16 user input buttons
20 user programming circuitry
22 controller
24 display
26 power source
28 air inlet
30 airflow sensor
31 printed circuit board (PCB)
32 sensor cavity or chamber
34 chamber wall
42 cartridge housing
44 chamber or reservoir
46 wick
48 aerosol generator
50 mouthpiece outlet
51 airflow path through reusable part
52 airflow path through cartridge

1. A controller for an aerosol delivery system comprising an aerosol generator configured to generate aerosol from aerosol-generating material, the controller being configured to:
a) for a first time period, repeatedly measure a parameter of an aerosol generator or an aerosol-generating material and, in response, dynamically control a first, variable power supplied to the aerosol generator, dependent on the measured parameter; and
b) after the first time period, supply a second, constant power to the aerosol generator.

2. The controller of claim 1, wherein the first time period is a predetermined time period.

3. The controller of claim 2, wherein the first time period is within the range 0.1-5 seconds, 0.25-2.5 seconds, 0.3-1.5 seconds or 0.5-1.0 seconds.

4. The controller of claim 1, wherein the first time period is:
a) a time period until the measured parameter reaches a target value; or
b)a time period until the measured parameter reaches a target value for at least a threshold length of time; or
c) a time period until a predetermined difference between a target value and the measured parameter is reached.

5. The controller of claim 1, wherein the first time period is:
a) a time period until a predetermined first supplied power or duty cycle is reached;
b) a time period until a predetermined first supplied power or duty cycle has been supplied for at least a threshold length of time or number of cycles.

6. The controller of claim 5, wherein the predetermined first supplied power or duty cycle is:
a) ≤70%, ≤60%, ≤50%, ≤40% or ≤30% of a maximum power; or
b) ≤70%, ≤60%, ≤50%, ≤40% or ≤30% of a maximum duty cycle; or
c) ≤70%, ≤60%, ≤50%, ≤40% or ≤30% absolute duty cycle.

7. The controller of claim 1, wherein the second, constant power is
a) ≤70%, ≤60%, ≤50%, ≤40% or ≤30% of a maximum power;
b) ≤70%, ≤60%, ≤50%, ≤40% or ≤30% of a maximum duty cycle; or
c) ≤70%, ≤60%, ≤50%, ≤40% or ≤30% absolute duty cycle.

8. The controller of claim 1, wherein the controller is configured to determine the first time period and/or the second, constant power based on a user's preceding puff or puff pattern.

9. The controller of claim 8, wherein the controller is configured to determine the first time period as a predetermined fraction of the user's puff duration, optionally wherein the predetermined fraction is 25%, 50% or 75%.

10. (canceled)

11. The controller of claim 8, wherein the controller is configured to determine the second, constant power based on a steady-state approximation of at least part of a user's preceding puff or puff pattern.

12. The controller of claim 1, further comprising a sensor for identifying the aerosol-generating material, wherein the controller is configured to adjust, dependent on the identification:
a) the first time period; and/or
b) a range for the first, variable power supplied to the aerosol generator for the first time period; and/or
c) the second, constant power supplied after the first time period.

13. The controller of claim 1, wherein the controller is configured to repeatedly determine a difference between the parameter and a target value, and in response, dependent on the difference, dynamically control the first, variable power supplied to the aerosol generator.

14. The controller of claim 1, wherein the parameter of the aerosol generator or aerosol-generating material relates to:
a) a temperature or resistance of the aerosol generator; or
b) a temperature or viscosity of the aerosol-generating material.

15. The controller of claim 1, wherein the first, variable power is determined by:
a) if the target value exceeds the measured parameter by greater than or equal to a first predetermined amount, then supplying a first predetermined power to the heater; and
b) if the target value exceeds the measured parameter but by less than the first predetermined amount, then supplying a second predetermined power to the heater that is lower than the first power.

16. The controller of claim 1, wherein the controller comprises a proportional or PID controller configured to repeatedly measure the parameter and dynamically control the power supplied for the first time period; and/or wherein the controller is configured to measure the parameter every 1-10 ms and control the first, variable power supplied to the aerosol generator dependent thereon.

17. (canceled)

18. The controller of any preceding claim, wherein the controller is configured to supply the second, constant power to the aerosol generator for a second time period and thereafter, supply a third, constant power to the aerosol generator.

19. An aerosol delivery system comprising the controller of claim 1, further comprising:
a) an aerosol generator wherein the aerosol generator is configured to heat the aerosol-generating material; and/or
b) a cartridge or cartomizer housing an aerosol-generating material for generating aerosol for inhalation by a user; and/or
c) a power source.

20. (canceled)

21. The controller of claim 1, wherein the controller is configured to:
a) for a first time period during a puff, repeatedly measure a parameter of an aerosol generator or an aerosol-generating material and, in response, dynamically control a first, variable power supplied to the aerosol generator, dependent on the measured parameter; and
b) after the first time period and during the same puff, supply a second, constant power to the aerosol generator.

22. A method for controlling an aerosol delivery system, comprising:
a) for a first time period, repeatedly measuring a parameter of an aerosol generator or an aerosol-generating material and, in response, dynamically controlling a first, variable power supplied to the aerosol generator, dependent on the measured parameter; and
b) after the first time period, supplying a second, constant power to the aerosol generator.

23. A computer program product or computer-readable storage medium comprising instructions which, when executed by a controller, cause the controller to carry out the method of claim 22.
